(19) United States
(12) Patent Application Publication
(10) Pub. No.: US 2012/0141340 A1
(43) Pub. Date: Jun. 7, 2012

(54) LIQUID RECEPTACLE

(75) Inventors: Lars Rosengren, Uppsala (SE); Johan Svensson, Uppsala (SE); Tomas Agren, Uppsala (SE); Mathias Osmark, Solna (SE); Per Stromberg, Uppsala (SE)

(73) Assignee: GE HEALTHCARE BIO-SCIENCES AB, Uppsala (SE)

(21) Appl. No.: 13/390,209

(22) PCT Filed: Aug. 24, 2010
(86) PCT No.: PCT/SE2010/050911

§ 371 Date: Feb. 13, 2012

(30) Foreign Application Priority Data
Aug. 26, 2009 (SE) 0950611-4

(51) Int. Cl. B01L 3/00; B01L 99/00; B01L 3/14

(52) U.S. Cl. 422/549; 422/552; 422/547; 422/568; 422/569

(57) ABSTRACT

Liquid receptacle with an opening for receiving liquid dispensed at a distance there above, wherein the receptacle comprises a liquid receiving member arranged in the vicinity of the opening and at an angle with respect to the motion of dispensed liquid to receive and direct dispensed liquid into the receptacle.

### CROSS-REFERENCE TO RELATED APPLICATIONS

This application is a filing under 35 U.S.C. §371 and claims priority to international patent application number PCT/SE2010/050911 filed Aug. 24, 2010, published on Mar. 3, 2011, as WO 2011/025449, which claims priority to patent application number 0950611-4 filed in Sweden on Aug. 26, 2009.

### Field of the Invention

The present invention pertains to the field of liquid receptacles, particularly to liquid receptacles for receiving liquid dispensed at a distance there above.

### BACKGROUND OF THE INVENTION

In many situations, such as in many types of fraction collectors, liquid is dispensed at a distance above the receptacle. When liquid is dispensed from a nozzle as a stream or in the form of drops are into a receptacle or vessel containing liquid, there are often minute droplets generated, that actually may fly up higher than the entrance opening of the receptacle. Such droplets may in fact reach the nozzle and foul it. In the case of fraction collectors, this can be seen as salt stains on the fraction dispensing nozzle, particularly with high salt eluents. These stains can constitute a problem, as they disrupt nozzle functions, such as optical sensor arrangements or the like located at the nozzle. Another, in some cases more severe, consequence of these droplets could occur if they jump over to a nearby tube or well. It has been found that up to 0.1% or more of the supposed contents of a well may be found in another nearby well, in a normal fractionation case in a 96 well Deep Well plate as a result of this “splashing” effect. In an extremely sensitive application this could be devastating.

The reasons for this effect are suggested to be both mechanical and electrostatic. As the droplet strikes a liquid surface a shower of minute droplets are created. Most of these fall directly back into the liquid, but some of them can fly as high as out of the well or tube. According to an electrostatic theory, if the liquid in the well and the drop together has a high enough charge, positive or negative, there is a chance that the small droplet created at impact is repelled by the static liquid, hence “pushed” out of the well/tube.

### SUMMARY OF THE INVENTION

The object of the invention is to provide a new liquid receptacle and liquid receptacle lid, which overcomes one or more drawbacks of the prior art. This is achieved by the liquid receptacle and liquid receptacle lid as defined in the independent claims.

One advantage with such a liquid receptacle is that creation of droplets by the splash effect is minimized by reducing the energy of the drop impact upon entrance to the receptacle.

Further scope and applicability of the present invention will become apparent from the detailed description given hereinafter. However it should be understood that a detailed description and specific examples while indicating preferred embodiments of the invention are given by illustrations only. There are changes and modifications in the spirit and scope of the invention which will become apparent to those skilled in the art from the detailed description below.

### BRIEF DESCRIPTION OF THE DRAWINGS

FIG. 1 is a perspective view of a well plate with a liquid receptacle lid according to the present invention;

FIG. 2 is a perspective view of a test tube cassette with a liquid receptacle lid;

FIGS. 3a and 3b schematically illustrates a liquid receptacle in the form of a well plate.

### DETAILED DESCRIPTION OF THE INVENTION

According to one embodiment, there is provided a liquid receptacle with an opening for receiving liquid dispensed at a distance there above, e.g. drops/stream from a fraction collector nozzle. In order to reduce the energy of the dispensed liquid impact upon entrance to the receptacle, the receptacle comprises a liquid receiving member arranged in the vicinity of the opening and at an angle with respect to the motion of dispensed liquid to receive and direct dispensed liquid into the receptacle. As mentioned above, the disclosed liquid receptacle is suitable to be used as a fraction collection receptacle in fraction collectors, but it may be used in any application wherein a lab receptacle is arranged to receive liquid dispensed at a distance there above, especially when the receptacle is a part of an array of receptacles such as a well in a well plate with a plurality of wells, or a test tube in a cassette with a plurality of test tubes.

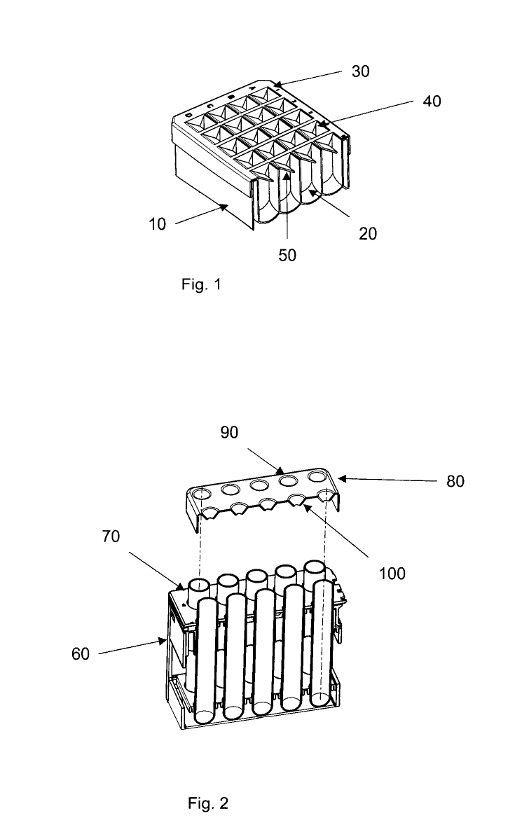

In the embodiments disclosed in FIGS. 1 and 2, the liquid receiving member is formed in a lid attached to the top of the liquid receptacle. In FIG. 1 a plurality liquid receptacles are provided in the form of an array of wells 20 in a well plate 10. Such well plates 10 are commonly used in the field of lab scale liquid handling and are available in a large number of formats and configurations. A splash preventing lid 30 is formed to be arranged on top of the well plate 10 and it comprises a plurality of openings 40, each associated with a well in the well plate 10. At each opening 40, there is provided a liquid receiving member 50 to receive and direct dispensed liquid into the associated well 20.

In FIG. 2 there is shown a cassette 60 supporting a plurality of test tubes 70 in an array pattern. A splash preventing lid 80 arranged to be placed on top of the test tube cassette assembly. The lid comprises a plurality of openings 90, each associated with a test tube 70 in the cassette 60. At each opening 90, there is provided a funnel shaped liquid receiving member 100 to receive and direct dispensed liquid into the associated test tube 70.

The lids 30, 80 will also serve as just lids, preventing any droplets from leaving the receptacle from below. After the liquid dispensing operation the lid may be removed to provide a larger access opening to the liquid receptacles in order to withdraw liquid there from e.g. using an auto-sampler or the like.

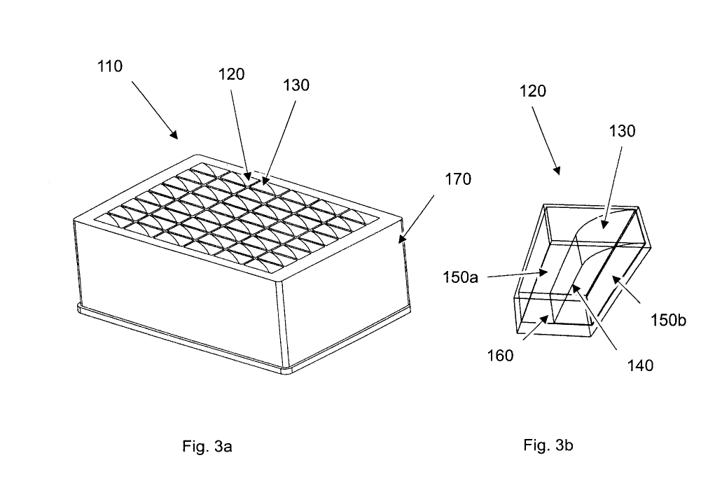

In the embodiment disclosed in FIGS. 3a and 3b, the liquid receiving member is of the liquid receptacle. FIGS. 3a and 3b shows a well plate 110 wherein each well 120 is provided with an integrated liquid receiving member 130 formed as an integrated part of the well plate 110. FIG. 3b shows one well 120 partially transparent to illustrate the interior design of the well. In the disclosed embodiment, the liquid receiving member 130 is a curved surface providing an inclined liquid reception surface. The liquid receiving member 130 is provided with an elongated division member 140, dividing the well 120 into two compartments 150a and 150b with a communication opening 160 at the bottom portion of the well 120. By this design the well plate may be handled in a tilted position with edge 170 downwards if desired, as long as the liquid volume in each well is less than the volume of compartment 150b, or even upside down if turned over in the correct way. As is shown in this embodiment, the free opening area for access to the well needs to be large enough to provide access to the liquid dispensed therein.

As is shown in FIGS. 1-3, the liquid receiving member 50, 90 is arranged to provide an inclined surface for the droplet to hit. Since the drop hits the inclined surface at an angle, most energy is lost at the impact without creating these minute droplets. The drop subsequently slides down the plane, and either reaches the wall to slide down against, or falls directly to the bottom, but now from a much lower distance, hence creating a lot less droplets at impact. In order to achieve the desired reduction of energy of the impact of the dispensed liquid, the liquid receiving member may be arranged at an angle less than 60o and more than 30o with respect to the motion of dispensed liquid. As is exemplified by the figs., the liquid receiving member may be of any suitable shape capable of reducing the impact energy of dispensed liquid.

In order to achieve the desired effect of reduced creation of droplets, the dispensing of liquid have to be controlled so that dispensed liquid, hits the liquid receiving member before it reaches the liquid compartment of the well or tube. In order to promote this for liquid receptacles with a small liquid opening, such as well plates with a large number of wells, the liquid receiving members are preferably formed in a lid and they preferably cover an area exceeding 50% of the opening.

The above examples illustrate specific aspects of the present invention and are not intended to limit the scope thereof in any respect and should not be so construed. Those skilled in the art having the benefit of the teachings of the present invention as set forth above, can effect numerous modifications thereto. These modifications are to be construed as being encompassed within the scope of the present invention as set forth in the appended claims.

1. A liquid receptacle with an opening for receiving liquid dispensed at a distance there above, wherein the receptacle comprises a liquid receiving member arranged in the vicinity of the opening and at an angle with respect to the motion of dispensed liquid to receive and direct dispensed liquid into the receptacle.

2. The liquid receptacle of claim 1, wherein the liquid receiving member is formed in a lid attached to the top of the liquid receptacle.

3. The liquid receptacle of claim 1, wherein the liquid receiving member is formed as an integrated part of the liquid receptacle.

4. The liquid receptacle of claim 1, wherein it is a fraction collection receptacle.

5. The liquid receptacle of claim 1, wherein it is a well in a well plate comprising a plurality of wells.

6. The liquid receptacle of claim 1, wherein it is a test tube.

7. The liquid receptacle of claim 1, wherein the liquid receiving member cover an area exceeding 50% of the opening.

8. The liquid receptacle of claim 1, wherein the liquid receiving member is arranged at an angle less than 60° and more than 30° with respect to the motion of dispensed liquid.

9. A liquid receptacle lid to be arranged on a liquid receptacle, with an opening for receiving liquid dispensed at a distance there above and for directing said liquid into the liquid receptacle, wherein the lid comprises a liquid receiving member arranged in the vicinity of the opening and at an angle with respect to the motion of dispensed liquid to receive and direct dispensed liquid into the receptacle.

10. The liquid receptacle lid of claim 8, comprising a plurality of openings each to be associated with a liquid receptacle in an array of receptacles.
